(19) United States
(12) Patent Application Publication
(10) Pub. No.: US 2015/0295466 A1
(43) Pub. Date: Oct. 15, 2015

(54) METHOD FOR SEALING ELECTRIC MOTORS FOR THE APPLICATION OF LUBRICATION BY MIST

(71) Applicants: Germán GONZÁLES BERNAL, (US); Carlos Jorge GANZÁLEZ BERNAL, Mexico DF (MX)

(72) Inventors: German Florencio Gonzales Bernal, Mexico City (MX); Carlos Jorge Gonzalez Bernal, Mexico City (MX)

(21) Appl. No.: 14/439,910

(22) PCT Filed: Nov. 1, 2012
(86) PCT No.: PCT/MX2012/000109

§ 371 Date: Apr. 30, 2015

(51) Int. Cl. H02K 5/16; F16J 15/16; H02K 5/20; H02K 15/00; H02K 15/16

(52) U.S. Cl. CPC H02K 5/16; H02K 15/0006; H02K 15/165; H02K 5/20; F16J 15/16

(57) ABSTRACT

A sealing arrangement for an electric motor having a drive shaft passing through a back cover and through a housing chamber holding bearings that surround the drive shaft, the sealing arrangment including a bushing disposed within the back cover and surrounding the drive shaft for preventing leakage of lubricant and supporting the drive shaft, the bushing made from a composite material that includes carbon fibers suspended in a PTFE matrix.

### FIELD OF THE DISCLOSURE

The present disclosure relates generally to the field of electric motors and relates more specifically to a method and a device for applying a fluid-tight seal to a bearing housing of an electric motor for preventing lubricant from leaking out of the bearing housing.

### BACKGROUND OF THE DISCLOSURE

Proper lubrication of bearings in rotating machinery, such as electric motors, is essential to the operation and durability of such machinery. It is also important that lubricant not be allowed to leak from the bearing housings of electric motors, since such leakage can result in overheating and damage to the coils and other components of an electric motor. In recent years, it has become common practice to use frequency variation to control the speeds of electric motors. This hinders the effectiveness of fluid seals and lubrication systems that depend on the rotational speeds of electric motors.

As a standard practice, grease is used to lubricate the bearings of motors. Grease is typically injected into a bearing housing using a grease fitting on a manual grease pump. Alternatively, a quantity of grease can be permanently sealed inside of a bearing housing during manufacture of the housing.

One disadvantage associated with using grease for lubrication of a motor bearings is that if grease is injected excessively, it can cause an increase in operating temperatures which can shorten the useful life of the bearings. Furthermore, applying grease in insufficient amounts or at an incorrect frequency may cause bearing failure due to lack of lubrication. Still further, excessive pressure from a grease pump may cause grease to overflow into a motor, which may result in fouling of the motor coils, damage to the rotor, and/or overheating. Still further, injecting grease into a bearing housing can result in the introduction of extraneous particles into the housing that may damage the bearings, causing premature failure.

In order to retain grease within a bearing housing, it is common to use elastomeric seals having rims that apply pressure to a motor's drive shaft using a circumferential spring. Such seals are susceptible to wear from foreign particles which can cause seal failure and erosion of a drive shaft. Such seals commonly fail before the end of the useful life of the bearings, and such failure may itself contribute to failure of the bearings.

In some cases oil is used instead of grease for the lubrication of motor bearings. However, oil is difficult to preserve and when it leaks it leaves the bearings with little or no lubrication, and therefore it is not reliable.

Instead of elastomer seals, mechanical seals, stoppers, labyrinth seals, or complicated sealing arrangements are used that seek to prevent the leakage of the lubricant and the entry of foreign particles or substances into a bearing housing. Each of these solutions is associated with certain disadvantages. For example, mechanical seals are often bulky, they have a very high cost, they wear out easily, they are sensitive to the presence of foreign particles or substances (such as water), they heat up easily, they do not support significant shaft vibration or axial or radial shifting, and they require very precise adjustment which is difficult to achieve in a motor.

Mechanical seals are generally not employed in motors due to space constraints and the difficulty associated with installing such seals with the required precision. Such seals generally do provide sufficient axial clearance to absorb differential expansion between the rotor and the stator or a motor. Furthermore, performing maintenance on such seals within a motor is not practical and the failure of such seals is difficult to detect in a timely fashion.

As an alternative to mechanical seals, labyrinth seals can be used. However, labyrinth seals are generally not sufficiently airtight, they are easily damaged, and they are not very effective for preventing leakage of lubricant or the entrance of foreign substances.

One solution to the aforementioned lubrication problems is to use a mist lubricant consisting of oil droplets suspended in a stream of air. As this lubricant flows through a bearing housing, it may lubricate the bearings, may dissipate heat, may clean the bearings, and may prevent the ingress of contaminants. Mist lubricant systems require that air flow and lubricant be maintained in the chambers of the bearing housing and that the lubricant not be allowed to leak and enter other parts of the motor. Sealing arrangements that are employed in mist lubricant systems therefore must offer proper fluid-tightness. Labyrinth seals do not offer sufficient fluid-tightness and mechanical seals are not practical because there is not enough space in an electric motor to house them.

Mist lubrication systems used in the lubrication pump bearings in refineries and in various other applications and industries have contributed greatly to the advancement of predictive and preventative maintenance of lubricated equipment because the runs such equipment become longer and their operation more stable. This allows pre-programming of fault intervention through more reliable prediction of bearing wear, thus facilitating unhurried and effective predictive and preventative maintenance. The application of mist lubrication systems in electric motors has been experimented with and analyzed with very favorable results.

The coils of modern electric motors are virtually encapsulated within resins which are not chemically affected by lubricating oils. However, for maintaining overall motor health, inner seals are typically employed that are formed from a compound of carbon, flurocarbonate, and Teflon material having high temperature and wear resistance. Such seals facilitate a reduction in the size of gaps between the drive shaft of a motor and the motor cover while preventing or mitigating leakage of mist lubricant. The mist lubricant is thereby able to remain in the operating cavity of the motor bearings where it may lubricate the bearings and eventually be expelled from an outlet port for collection and recovery.

In U.S. Pat. No. 6,177,744 to Williams, et al. a seal arrangement is proposed for electric motors that employ mist or spray lubrication. Particularly, a sealing device for a bearing chamber is disclosed in which a drive shaft of the motor rotates in contact with the sealing elements which prevent leakage of the lubricant. Such sealing elements are prone to premature wear and failure.

In JP Patent No. 2008232354 to NSK a sealing system is described that includes multiple rotational elements arranged to prevent the leakage of lubricating oil from a housing chamber of motor bearings. Such sealing systems are complicated and costly.

In JP Patent 2004286080 to Hitoshi, a system is described that is arranged to recover lubricating oil that axially leaks from a bearing housing. This system employs flexible sealing elements made of an oil repellent material. These elements may fail or may be rendered ineffective if oils having high detergent characteristics or additives that form highly tenacious lubricant films are used.

In the utility model application CN 201020300747.6 to Zhou Shaohua a sealing system is described that is made up mainly of labyrinth-type of components. Although these components may reduce oil leaks outside the housing chamber of the bearings and/or reduce the entrance of external fluids into the housing chamber, they exhibit the undesirable characteristics that are inherent to all labyrinth-type seals. For example, if the drive shaft of the motor vibrates significantly, or if the bearings fail, the sealing components may be seriously damaged.

Finally, a disadvantage associated with each of the above-described sealing systems is that when a bearing fails, or if there are large radial shifts in a motor's drive shaft due to excessive vibration (of the rotor itself or due to external loads), none of the sealing systems provide the drive shaft with significant radial support, thereby exposing other motor components to significant damage.

### SUMMARY

In view of the forgoing, it would be advantageous to provide a sealing arrangement and method for preventing the leakage of a lubricating mist used for the lubrication of electric motor bearings into unwanted areas of the motor. It would further be advantageous to provide such a sealing arrangement and method that provide a drive shaft of the motor with substantial radial support in the case of excessive drive shaft vibration and/or bearing failure.

In an exemplary embodiment of the present disclosure, a sealing arrangement is provided for an electric motor having a drive shaft passing through a back cover and through a housing chamber holding bearings that surround the drive shaft, the sealing arrangement including a bushing disposed within the back cover and surrounding the drive shaft for preventing leakage of lubricant and supporting the drive shaft, the bushing made from a composite material that includes carbon fibers suspended in a PTFE matrix.

In another exemplary embodiment of the present disclosure, a method for modifying an electric motor having a drive shaft passing through a back cover, a front cover, and a housing chamber holding bearings that surround the drive shaft to provide a sealing arrangement for a lubricant mist that is applied to the bearings is provided, the method including switching the front and back covers to change a direction of lubricant flow so that lubricant is fed to a side of the bearings that faces an interior of the motor, then flows back-to-front over the bearings, and exits the bearings on a side of the bearings that faces away from the motor. The method may further include forming an annular shoulder in the back cover surrounding the drive shaft for receiving an annular bushing, and installing the annular bushing in the shoulder, the bushing formed of a composite material including carbon fibers suspended in a PTFE matrix.

### BRIEF DESCRIPTION OF THE DRAWINGS

FIG. 1 is cross sectional side view illustrating components of an electric motor modified according to the present disclosure;

FIG. 2 is detailed cross sectional side view illustrating a sealing retainer in a front cover of the modified electric motor shown in FIG. 1;

FIG. 3 is detailed cross sectional side view illustrating a bushing in a back cover of the modified electric motor shown in FIG. 1.

### DETAILED DESCRIPTION

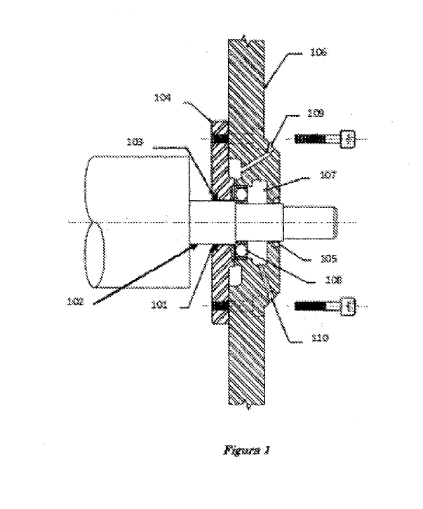

Referring to FIG. 1, an exemplary embodiment of a cylindrical seal or bushing 101 (hereinafter “the bushing 101”) in accordance with the present disclosure is shown. The bushing 101 may be installed in a back cover 104 of a motor surrounding a drive shaft 102 of the motor and may be formed of a composite material made of carbon fibers suspended in a matrix of fluorocarbon resin formed of polytetrafluoroethylene (PTFE). An example of such a composite material is manufactured by the DUPONT COMPANY under the trade name VESPEL. Properties of this type of material may include, but are not limited to: a hardness corresponding to a compression resistance on the order of 20 kpsi (140 MPa); a low thermal expansion coefficient (10⁻⁶ m/m° C.); a high temperature limit (−46° to 230° C.); chemical compatibility with hydrocarbons and high pressure-speed capacity.

Referring to FIG. 3, the cylindrical bushing 101 be manufactured with the following exemplary, non-limiting dimensions: an axial length 304 ranging from 0.250 to 0.750 inches (6.35 to 19.05 mm), a radial tolerance 303 of +0.0003 to +0.0015 inches (+0.00762 to +0.0381 mm) between its interior diameter and the diameter of the drive shaft 102, and a minimum radial thickness 302 of 0.2000 inches (5.08 mm). The bushing 101 may be securely mounted within an annular shoulder in the back cover 104 by press fit. A radial interference 301 between the outer diameter of the bushing 101 and a surface 103 (see FIG. 1) of the annular shoulder may be in a range of 0.004 to 0.015 inches (0.1016 to 0.381 mm) and preferably from 0.008 to 0.012 inches (0.2032 to 0.3048 mm).

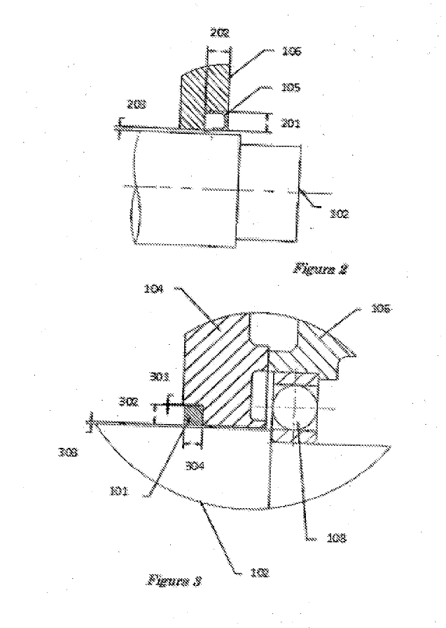

Referring to FIGS. 1 and 2, an annular cup seal or retainer 105 (hereinafter “the retainer 105”) having a “V” or “U” shaped cross section may be mounted in the front cover 106 surrounding the drive shaft 102 to prevent or mitigate the exit of the oil mist from the housing chamber 107 of the bearings 108 (described in greater detail below). The retainer 105 may be formed of a resilient material such as nitrile and may be devoid of any reinforcing springs or similar rigidizing support structures. The retainer may have a double lip arrangement to form an integral assembly with the modified back cover 104. The retainer 105 may have dimensions 201 and 202 that correspond to the diameter of the drive shaft 102. A gap between the retainer 105 and the drive shaft 102 may have a width 203 that may be in a range of 0.010 to 0.020 inches (0.254 to 0.508 mm), and preferably between 0.011 and 0.015 inches (0.2794 to 0.381 mm).

Referring to FIG. 1, the oil mist may be fed into an inlet port 109 in the front cover 106 and delivered to the bearings 108. The oil mist may then flow around the bearings 108 from back to front (left-to-right in FIG. 1), thereby lubricating and cooling the bearings 108. The oil mist may then flow into a housing chamber 107 within the front cover 106 and may finally be discharged through an outlet port 110 in the front cover 106, either into a container or into a lubricant collecting system (not shown) for recovery. The points of input and output of the oil mist into and out of the housing chamber 107, as well as for the injection and discharge of the oil mist into and out of the front cover 106, may be at vertically diametrically-opposed, 12 o'clock and 6 o'clock positions relative to the axis of the drive shaft 102.

In an alternative embodiment of the present disclosure, the cylindrical bushing 101 may be manufactured with an axial measurement 304 (see FIG. 3) of up to 1.5 inches (38.1 mm) to provide greater radial support in applications in which the drive shaft 102 may be subject to significant axial loads and/or vibration.

In another alternative embodiment of the present disclosure, the bushing 101 may be manufactured using materials made of metal fibers or fill, including, but not limited to, bronze, Babbitt alloys, etc., suspended in a PTFE matrix

In another alternative embodiment of the present disclosure, the retainer 105 may be replaced by a ring made of a composite material formed of carbon fibers suspended in a matrix of fluorocarbon resin made of polytetrafluoroethylene, PTFE, similar to the bushing 101. Such a ring may have a radial tolerance not exceeding about 0.010 inches (0.254 mm).

In accordance with the present disclosure, an exemplary method is provided for modifying an electric motor to prevent leakage of mist lubricant from a bearing housing thereof. In case of strong vibrations or failure of a bearing, the modification which is the object of this method may provide additional support to a motor shaft which may prevent or mitigate damage which may otherwise result from contact between the rotor and stator of the motor. Additionally, said method includes the design, manufacture, and installation of a smooth, high precision cylindrical seal in the form of a bushing with an interior finish that restricts the passage of the lubricant mist inside the motor.

The method of the present disclosure may prolong the operational life of motor bearings and, as a result, may improve the average time between bearing failures. Thus, the life of an electric motor may be prolonged because operational temperatures are reduced, the risk for catastrophic destruction of the motor is minimized, manufacturing loss risk is reduced, and, in the case of bearing failure, resulting damage will not be generalized to surrounding components, thereby making a specific repair possible.

The exemplary method may include changing a direction of lubricant flow in an electric motor, causing the lubricant to flow back-to-front from a side of the bearings of the motor that faces towards the interior of the motor, through the bearings, and out through the side of the bearings that faces the away from the interior of the motor towards an air connection or a purge collection system.

In a step of the exemplary method of the present disclosure, an inspection and maintenance control process may be performed to ensure that an electric motor that is to be modified is in good working order.

In a further step of the exemplary method, front and back covers at each end of the motor may be switched to change the direction of lubricant flow so that the lubricant is fed to the side of the bearings that faces the interior of the motor, then flows back-to-front over the bearings, and exits the bearings on a side of the bearings that faces away from the motor towards an air connection or a purge collection element or system.

In a further step of the exemplary method, an annular shoulder may be formed in the back cover surrounding the shaft opening for receiving a composite bushing, such as the bushing 101 described above. The bushing may be installed in the annular shoulder with a press fit of 0.004 to 0.015 inches (i.e., the bushing may be press mounted in the back cover). The radial tolerance between the annular shoulder and the bushing may be checked during machining of the annular shoulder, and if it is more than 0.002 inches (0.051 mm), the annular shoulder may be covered with metal and machined again to achieve the desired radial tolerance to ensure concentricity with the bushing.

A further step of the exemplary method may include checking the bearing housing chamber of the motor and, if necessary, machining the housing chamber to dimensions that are suitable for accommodating the bearings.

In a further step of the exemplary method, adjustments in the shaft may be checked in the working zone of the bearings and corrected if necessary. Measurements may be provided according to manufacturer's standards for bearings filled with MIG welding solder or with plasma metal deposition. The metal deposition will be machined and restored to factory dimensions and finish.

A further step of the exemplary method may include dynamically balancing the rotor of the electric motor, especially if the working zone of the bearings is repaired by adding metal.

A further step of the exemplary method may include arming the engine in its entirety and installing double lip retainers of nitrile material, such as the retainer 105 described above, on the outside of the motor covers, giving a setting of between 0.001 to 0.015 inches (0.00254 to 0.381 mm) as a maximum torque with the shaft.

A further step of the exemplary method may include connecting an engine mist lubrication system to the motor cover. The lubrication system may be installed within 30 minutes of performing a vacuum test. The points of input and output of the mist lubrication system into and out of the bearing housing chamber, as well as for the injection and discharge of the mist lubrication system into and out of the motor cover, may be installed at vertically diametrically-opposed, 12 o'clock and 6 o'clock positions relative to the axis of the shaft.

A further step of the exemplary method may include manufacturing a composite bushing, such as the bushing 101 described above, for installation in the motor cover as described above.

In contrast to U.S. Pat. No. 6,177,744 to Williams, et al., the bushing of the present disclosure faces the inside of the motor. It does not have contact with the shaft and the passage of lubricant is mitigated by a strict radial clearance between the bushing and the shaft itself.

An additional difference relative to U.S. Pat. No. 6,177,744 to Williams, et al., is that the retainer of the present disclosure may be made of a polymer material, preferably of nitrile rubber, and may be devoid of springs or similar rigidizing support structures. This design prolongs the life of the retainer as well as the operational life of the shaft itself.

An additional difference relative to U.S. Pat. No. 6,177,744 to Williams, et al., is that the bushing of the present disclosure has the ability to provide radial support to the shaft as described above.

In contrast to Japanese Patent No. JP2008232354 to NSK, the arrangement of the present disclosure is very simple and does not require multiple rotary elements.

1-13. (canceled)

14. A sealing arrangement for an electric motor, the electric motor having a drive shaft passing through a back cover, the drive shaft further passing through a housing chamber holding bearings that surround the drive shaft, the sealing arrangement comprising:
a bushing disposed within the back cover and surrounding the drive shaft for preventing leakage of lubricant and supporting the drive shaft;
wherein the bushing is made from a composite material that includes carbon fibers suspended in a PTFE matrix.

15. The sealing arrangement of claim 14, wherein the bushing has an axial length in a range of 0.250 to 0.750 inches.

16. The sealing arrangement of claim 14, wherein the bushing has a minimum radial thickness of 0.200 inches.

17. The sealing arrangement of claim 14, wherein the bushing is press fit in an annular shoulder in the back cover.

18. The sealing arrangement of claim 14, wherein a radial interference between an outer diameter of the bushing and a surface of the annular shoulder is in a range of 0.004 to 0.015 inches.

19. The sealing arrangement of claim 14, further comprising a front cover disposed on an opposite side of the back cover relative to the motor, the drive shaft extending through an annular retainer in the front cover.

20. The sealing arrangement of claim 19, wherein the annular retainer has a “U” shaped cross section.

21. The sealing arrangement of claim 19, wherein the annular retainer is formed of nitrile.

22. The sealing arrangement of claim 19, further comprising an inlet port and an outlet port formed in the front cover, each of the inlet port and the outlet port and extending from a respective opening in the front cover to the bearings.

23. The sealing arrangement of claim 19, wherein the inlet port is disposed at a 12 o'clock position relative to an axis of the drive shaft and the outlet port is disposed at a 6 o'clock position relative to the axis of the drive shaft.

24. A method of modifying an electric motor, the electric motor having a drive shaft passing through a back cover, a front cover, and a housing chamber holding bearings that surround the drive shaft to provide a sealing arrangement for a lubricant mist that is applied to the bearings, the method comprising:
switching the front and back covers to change a direction of lubricant flow so that lubricant is fed to a side of the bearings that faces an interior of the motor, flows back-to-front over the bearings, and exits the bearings on a side of the bearings that faces away from the motor;
forming an annular shoulder in the back cover surrounding the drive shaft for receiving an annular bushing; and
installing the annular bushing in the shoulder, the bushing formed of a composite material including carbon fibers suspended in a PTFE matrix.

25. The method of claim 24, further including machining the housing chamber to dimensions that are suitable for accommodating the bearings.

26. The method of claim 24, further including restoring the bearings to factory dimensions and finish.

27. The method of claim 24, further including dynamically balancing a rotor of the electric motor.

28. The method of claim 24, further including installing an annular retainer in the front cover, the annular retainer surrounding the drive shaft.

29. The method of claim 28, wherein the retainer is a double lip retainer formed of nitrile.

30. The method of claim 24, further comprising connecting an engine mist lubrication system to the front cover.

31. The method of claim 30, further comprising connecting the engine mist lubrication system within 30 minutes prior to performing a vacuum test.

32. The method of claim 31, wherein connecting the engine mist lubrication system includes installing an inlet port in the front cover at a 12 o'clock position relative to an axis of the drive shaft and installing an outlet port in the front cover at a 6 o'clock position relative to an axis of the drive shaft.
